(19) United States
(12) Patent Application Publication
(10) Pub. No.: US 2007/0267524 A1
(43) Pub. Date: Nov. 22, 2007

(54) GPS CONTROL SYSTEM AND METHOD FOR IRRIGATION SYSTEMS

(76) Inventor: David Mack, Omaha, NE (US)

Correspondence Address: HOVEY WILLIAMS LLP, 2405 GRAND BLVD., SUITE 400, KANSAS CITY, MO, 64108, US

(21) Appl. No.: 11/419,117

(22) Filed: May 18, 2006

(51) Int. Cl. B05B 3/00

(52) U.S. Cl. 239/729; 239/728; 239/69; 239/730

(57) ABSTRACT

An irrigation system includes a central pivot connected to a source of fluid; at least one mobile intermediate tower; a mobile end tower; a plurality of support sections spanning the main tower, the intermediate tower, and the end tower; a fluid distribution conduit supported by the support sections and coupled to the source of fluid; and a plurality of water-emitting devices supported along the length of the fluid distribution conduit for delivering fluids from the conduit to crops beneath the irrigation system. A main controller is positioned at the main tower for controlling speed, direction, and fluid application functions of the irrigation system. An independent GPS controller is positioned at the end tower and includes a GPS receiver and a computing device. The GPS receiver receives satellite signals from a plurality of GPS satellites and determines a current location of the end tower as a function of the received satellite signals. The computing device is coupled with the GPS receiver for controlling operation of selected ones of the water emitting devices based on the current location of the end tower and independent from the main controller.

### BACKGROUND OF THE INVENTION

1. Field of the Invention

The present invention relates to agricultural irrigation systems. More particularly, the invention relates to a center pivot irrigation system with a GPS controller which controls selected functions of the system independently of a main controller.

2. Background

Agricultural irrigation systems are commonly used to irrigate crops. One type is a center pivot system which includes, among other things: a central pivot communicating with a pressurized water supply; a series of moveable support towers connected to the central pivot and one another by truss sections; an elevated water distribution conduit supported by the truss sections; and a number of sprinkler heads, spray guns, drop nozzles, or other fluid emitting devices spaced along the length of the conduit. The support towers are supported on wheels that are driven at slow speeds to move the towers in a generally circular path about the central pivot to irrigate a large tract of land.

Center pivot irrigation systems also often include high pressure sprayers, or end guns, mounted on their end towers. The end guns are activated at the corners of a field or other designated areas to increase the amount of land that can be irrigated. Booster pumps may be coupled with the end guns to increase the water pressure to the end guns for providing an even larger watering pattern.

Center pivot irrigation systems also often include a main controller positioned at or near the central pivot for controlling speed, direction, and fluid application functions. These controllers can be used to adjust the towers' speed and/or direction, turn on or shut off selected towers or nozzles at predetermined locations in a field, and perform other control functions. To control functions of the irrigation system based on location, the main controller must be coupled with a location-determining mechanism.

A common location determining mechanism for central pivot irrigation systems is an encoder mounted at the central pivot. The encoder moves when a shaft at the central pivot moves and thus provides an indication to the main controller that the entire irrigation system is moving. Unfortunately, the encoder cannot sense actual movement of any of the towers other than the one closest to the central pivot. This is a problem because some center pivot irrigation systems are equipped with an articulating pivoting joint at one of the mobile towers that permits the mobile towers downstream of the pivoting joint to continue moving after the central pivot and the mobile towers upstream of the pivoting joint have stopped. Because an encoder is incapable of providing the main controller an accurate indication of the position of any mobile towers that move independently of the central pivot, the main controller cannot always activate the end guns on the end tower and water emitting devices on any intermediate towers at the proper time. Moreover, it is difficult to accurately stop, reverse and/or change the speed of any mobile towers whose exact locations are not known.

Recently, irrigation systems have been equipped with Global Positioning System (GPS) receivers to more accurately determine the position of their end towers and other mobile towers. For example, U.S. Pat. No. 6,928,339 discloses an irrigation system including a GPS-based controller positioned on its end tower and a main controller positioned at its central pivot. The GPS controller determines the current coordinates (latitude and longitude) of the end tower and compares these coordinates to the known fixed coordinates of the central pivot. Based on this comparison, the GPS controller determines the azimuth between the central pivot and the end tower and transmits the azimuth value to the main controller. The main controller then uses the azimuth value to control one or more functions of the irrigation system. For example, the azimuth value can be compared to reference azimuth values to determine when to start and stop an end gun on the end tower.

Although the GPS control scheme disclosed in the '339 patent accurately calculates the position of the end tower in many applications, it suffers from several disadvantages. For example, the GPS controller and the main controller must work together to control operation of the end tower end guns, necessitating a communication path between the two controllers (the '339 patent discloses a twisted pair). This increases the cost and complexity of the control system and increases the chance of failure should either controller or the communication path therebetween malfunction. Moreover, as with encoders positioned at the central pivot, the GPS control scheme in the '339 patent does not work well with irrigation systems equipped with pivoting joints at any of the mobile towers. This is because the control system of the '339 patent controls functions of the irrigation system based on the azimuth between the central pivot and the end tower, and azimuth alone cannot accurately determine the position of the end tower when one of the mobile towers is equipped with an articulating pivot joint. For example, the position of the end tower at an azimuth of 30° when the end tower is aligned with the central pivot is different from the position of the end tower at the same azimuth when the end tower is articulated relative to the central pivot.

Accordingly, there is a need for an improved system and method for determining the position of the end tower and other mobile towers of a center pivot irrigation system that move independently of the central pivot.

### SUMMARY OF THE INVENTION

The present invention solves the above-described problems and provides a distinct advance in the art of irrigation systems. More particularly, the present invention provides a GPS control system and method for a center pivot irrigation system that controls selected functions of the irrigation system independently from a main controller and/or encoder positioned at the central pivot.

One embodiment of the invention is an irrigation system comprising a central pivot connected to a source of fluid; at least one mobile intermediate tower; a mobile end tower; a plurality of support sections spanning the main tower, the intermediate tower, and the end tower; a fluid distribution conduit supported by the support sections and coupled to the source of fluid; and a plurality of water-emitting devices supported along the length of the fluid distribution conduit for delivering fluids from the conduit to crops beneath the irrigation system. A main controller is positioned at or near the main tower for controlling speed, direction, and fluid application functions of the irrigation system. The main controller is preferably coupled with an encoder or other position sensing mechanism. An independent GPS controller is positioned at or near the end tower and includes a GPS receiver and a computing device. The GPS receiver is operable for receiving satellite signals from a plurality of GPS satellites and for determining a current location of the end tower as a function of the received satellite signals. The computing device is coupled with the GPS receiver for controlling operation of selected ones of the water emitting devices based on the current location of the end tower and independent from the main controller. For example, the computing device may receive current location readings from the GPS receiver, compare the location readings to known reference positions, and then turn on an end gun when the current location reading matches a first known reference position and turn off the end gun when the current location reading matches a second known reference position.

Importantly, the GPS controller of the present invention can accurately determine the position of the end tower, or any other mobile towers which sometimes move independently of the central pivot, without communicating with or receiving assistance from the main controller or the encoder at the central pivot. This provides more accurate and reliable position sensing and control in all applications, even when one or more of the mobile towers are equipped with articulating pivot joints.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is an isometric view of a center pivot irrigation system with which a GPS control system in accordance with the present invention may be employed.

FIG. 2 is a schematic plan view of the irrigation system showing some of its spans articulated around an obstruction.

FIG. 3 is a schematic diagram of a GPS system which may be used to implement certain aspects of the present invention.

FIG. 4 is a block diagram of a GPS controller constructed in accordance with a preferred embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

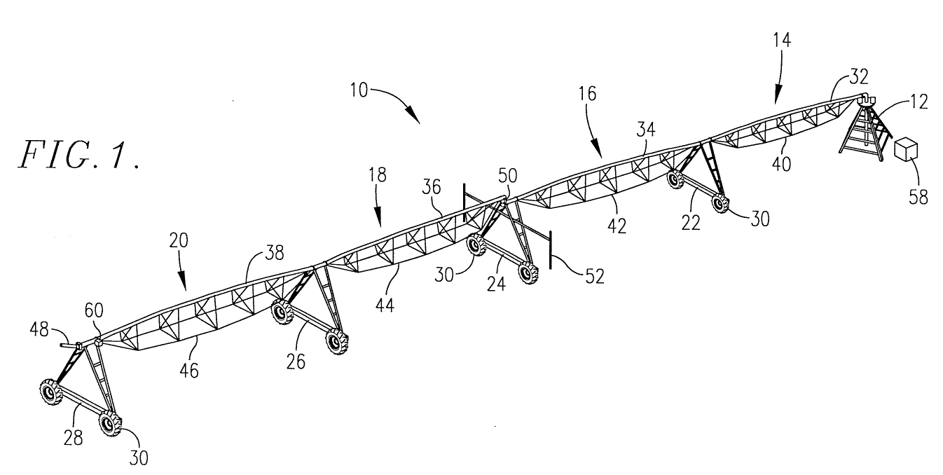

The irrigation system 10 selected for purposes of illustration in FIG. 1 is a center pivot irrigation system that includes a central pivot 12 having access to a well, water tank, or other source of fluids. The fluid source may be coupled with a tank or other source of agricultural products to inject fertilizers, pesticides and/or other chemicals into the fluids for application during irrigation. The irrigation system 10 also includes a number of interconnected spans 14, 16, 18, 20 supported by mobile towers 22, 24, 26 (also referred to herein as “intermediate” towers) and an end mobile tower 28. Those skilled in the art will appreciate that the irrigation system 10 may include any number of spans and mobile towers. It will also be recognized that the principles of the present invention are not limited to use with a center pivot system but may also be employed with other types of irrigation systems, including for example, lateral move systems and other types which do not employ a fixed center pivot tower.

The wheels 30 of the mobile towers 22, 24, 26, 28 are driven by suitable drive motors. Although not required, some or all of the towers may be equipped with steerable wheels pivoted about upright axes by suitable steering motors so that the towers can follow a predetermined track presented by a buried cable or the like. U.S. Pat. No. 4,508,269 in the name of Davis et al. is hereby incorporated by reference into the present specification for a disclosure of ground drive motors and steering motors associated with an irrigation machine. As is also well known, the drive motors for the towers are controlled by a suitable safety system such that they may be slowed or completely shut down in the event of the detection of an adverse circumstance, all of which is disclosed, for example, in U.S. Pat. No. 6,042,031 to Christensen, et al. incorporated herein by reference.

Each of the spans 14, 16, 18, 20 also includes a conduit section 32, 34, 36, 38 or other fluid distribution mechanism that is connected in fluid communication with all other conduit sections of the system to provide water along the length of the system to numerous sprinklers or other water emitting devices (not shown). The conduits 32, 34, 36, 38 are slightly arched or bowed when empty and are supported in such condition by truss-type frameworks 40, 42, 44, 46 or other supports.

One or more high pressure sprayers or end guns 48 may be mounted to the end tower 28. The end guns 48 are activated at the corners of a field or other designated areas to increase the amount of land that can be irrigated. Booster pumps may be coupled with the end guns to increase their range.

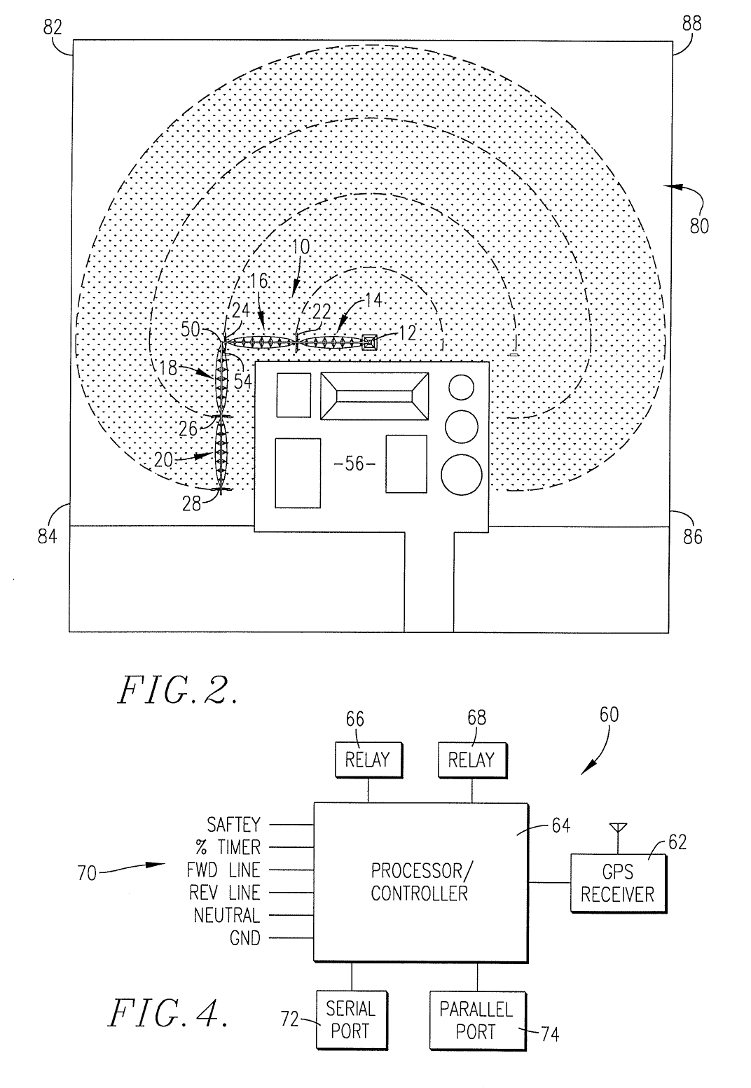

The irrigation system 10 also preferably includes an articulating pivot joint 50 positioned at one or more of the mobile towers to permit towers downstream from the pivot joint to continue moving after the central pivot 12 and towers upstream of the pivot joint 50 have stopped. For example, as illustrated in FIGS. 1 and 2, an articulating pivot joint 50 may be positioned at the mobile tower 24. When the mobile tower 24 reaches a predetermined location in a field or other area to be irrigated, a post 52 or other contact member attached to the mobile tower contacts a fixed barricade 54 which triggers a switch to automatically stop movement of the central pivot 12 and the mobile towers 22, 24 while permitting continued movement of the mobile towers 26, 28. This allows the spans 18, 20 downstream of the pivot joint 50 to articulate or bend around buildings 56 or other obstructions and move up to 165° in either direction relative to the mobile tower 24 to irrigate land which could not be reached without the articulating pivot joint. The articulating pivot joint is preferably a Zimmatic™ FieldPLUS Articulated Pivot™ provided by Lindsay™ Manufacturing Company, but may be any other pivot joint that permits the same articulating movement.

The irrigation system 10 also includes a main controller 58 positioned at or near the central pivot 12 for controlling certain speed, direction, and fluid application functions of the irrigation system. For example, the main controller 58 can be used to adjust the speed and/or direction of the mobile towers 22, 24, 26, 28, turn on or shut off selected towers or nozzles at predetermined locations in the field, and control other functions of the irrigation system. The main controller 58 preferably receives positional information from an encoder mounted at the center of the central pivot 12 inside a slip ring assembly.

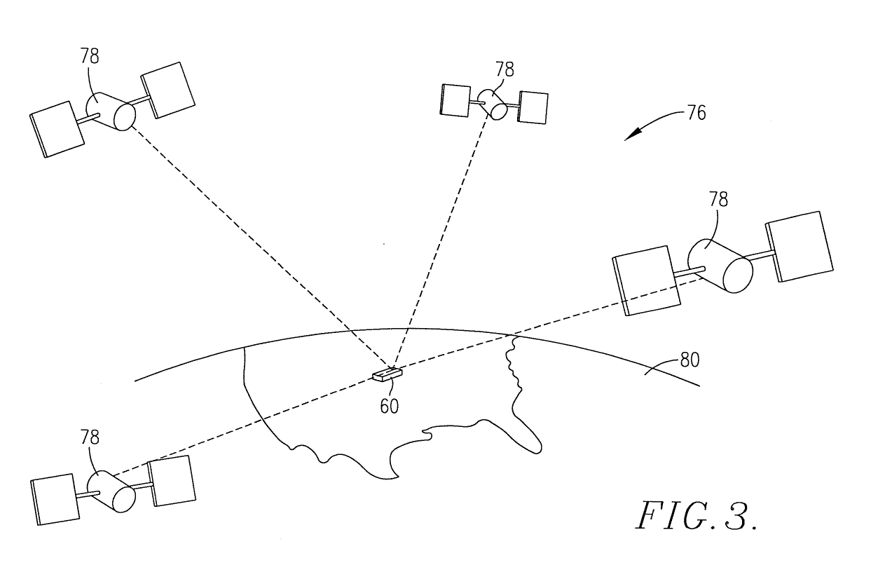

In accordance with one aspect of the present invention, the irrigation system 10 also includes a GPS controller 60 positioned at or on the end tower 28 for controlling selected functions of the irrigation system 10 independently from the main controller 58. The GPS controller 60 can be implemented with hardware, software, firmware, or a combination thereof, but preferably includes the components illustrated in FIG. 4. Specifically, a preferred embodiment of the GPS controller 60 comprises a location determining component 62, a computing device 64, one or more relays 66, 68, a plurality of inputs 70, an input port 72, and an output port 74, all enclosed in or supported on a weatherproof housing which protects the controller components from moisture, vibration, and impact. The GPS controller 60 may also include a display screen and a power source such as a battery pack or solar cell, or it may be hardwired to a power source associated with the main controller 58.

The location determining component 62 is preferably a global positioning system (GPS) receiver, and provides, in a substantially conventional manner, geographic location information for the GPS controller 60 and hence the end tower 28 to which it is attached. The location determining component 62 maybe, for example, a GPS receiver much like those provided in products by Garmin Corporation, Inc. of Olathe, Kans.

The GPS receiver 62 may include one or more processors, controllers, or other computing devices and memory for storing information accessed and/or generated by the processors or other computing devices. The GPS receiver is operable to receive navigational signals from GPS satellites to calculate a position of the GPS controller 60 as a function of the signals.

The GPS receiver also includes an antenna to assist in receiving signals. The antenna is preferably a GPS patch antenna or helical antenna but may be any other type of antenna that can be used with navigational devices. The antenna may be mounted directly on or in the GPS controller housing or may be mounted external to the housing. The antenna is preferably protected from adverse conditions, such as those described above, by being entirely enclosed within the housing. Additionally, any harmful physical contact that can occur from a user's accidental contact with a conventional, pointed, antenna is eliminated as the antenna has no sharp points protruding from the housing.

In general, the GPS is a satellite-based radio navigation system capable of determining continuous position, velocity, time, and direction information for an unlimited number of users. Formally known as NAVSTAR, the GPS incorporates a plurality of satellites which orbit the earth in extremely precise orbits. Based on these precise orbits, GPS satellites can relay their location to any number of receiving units.

The GPS system is implemented when a device specially equipped to receive GPS data such as the GPS controller 60 of the present invention begins scanning radio frequencies for GPS satellite signals. Upon receiving a radio signal from a GPS satellite, the device 60 can determine the precise location of that satellite via one of different conventional methods. The device 60 will continue scanning for signals until it has acquired at least three different satellite signals. Implementing geometrical triangulation, the device 60 utilizes the three known positions to determine its own two-dimensional position relative to the satellites. Acquiring a fourth satellite signal will allow the receiving device 60 to calculate its three-dimensional position by the same geometrical calculation. The positioning and velocity data can be updated in real time on a continuous basis by an unlimited number of users.

Although GPS enabled devices are often used to describe navigational devices, it will be appreciated that satellites need not be used to determine a geographic position of a the device 60 since any receiving device capable of receiving the location from at least three transmitting locations can perform basic triangulation calculations to determine the relative position of the receiving device with respect to the transmitting locations. For example, cellular towers or any customized transmitting radio frequency towers can be used instead of satellites. With such a configuration, any standard geometric triangulation algorithm can be used to determine the exact location of the receiving unit. In this way, the GPS controller 60 and the end tower 28 can be readily located geographically, if appropriately equipped to be a receiving unit.

FIG. 3 shows one representative view of a GPS denoted generally by reference numeral 76. A plurality of satellites 78 are in orbit about the Earth 80. The orbit of each satellite is not necessarily synchronous with the orbits of other satellites and, in fact, is likely asynchronous. A GPS receiver device such as the GPS controller 60 described in connection with preferred embodiments of the present invention is shown receiving spread spectrum GPS satellite signals from the various satellites 78.

The spread spectrum signals continuously transmitted from each satellite 78 utilize a highly accurate frequency standard accomplished with an extremely accurate atomic clock. Each satellite, as part of its data signal transmission, transmits a data stream indicative of that particular satellite. The GPS receiver 62 must acquire spread spectrum GPS satellite signals from at least three satellites for the GPS receiver device to calculate its two-dimensional position by triangulation. Acquisition of an additional signal, resulting in signals from a total of four satellites, permits the GPS receiver 62 to calculate its three-dimensional position.

The computing device 64 is coupled with the GPS receiver 62 for obtaining current location readings from the GPS receiver 62 and for controlling certain functions of the irrigation system 10 as a function of these location readings. As described in more detail below, the computing device 64 compares the current location readings from the GPS receiver 62 to reference positions to determine when to control certain functions of the irrigation system. The computing device 64 may be a processor, microcontroller, ASIC, or any other conventional programmable device.

The computing device 64 stores or has access to a computer program which performs the control functions describe herein. The computer program preferably comprises an ordered listing of executable instructions for implementing logical functions in the computing device. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The relays 66, 68 are activated by the computing device 64 for controlling operation of certain functions of the irrigation system 10. In a preferred embodiment, the relays 66, 68 are coupled to the end guns 48 on the end tower 28. Additional relays can also be provided for controlling other functions of the irrigation system such as operation of the powered wheels of the towers 26, 28, or valves for spray nozzles or other water-emitting devices supported on the conduit sections 36, 38.

The inputs 70 are provided for receiving data from the main controller 58. For example, the computing device 64 may receive a safety signal from the main controller which ensures safe alignment of the various spans of the irrigation system. The computing device 64 may also receive data which assists it in estimating the location of the end tower 28 when GPS signals are unavailable or when correction signals used to improve the accuracy of the GPS signals are not available. For example, the computing device may receive a % Timer signal which indicates the speed of the drive wheels of mobile towers 26, 28, and FWD and REV signals which indicate the direction of travel of mobile towers 26, 28. The computing device 64 may analyze these signals to determine how far the mobile towers 26, 28 have moved from a position at which GPS signals were lost. It is important to note, however, that the main controller inputs 70 to the GPS controller 60 are not required, as the GPS controller 60 can independently determine its location, and hence the location of the end tower 28, and can independently control certain functions of the irrigation system, such as the operation of the end guns 48.

The GPS controller 60 may also include a number of other inputs. The inputs may be buttons, switches, keys, an electronic touchscreen associated with the display, voice recognition circuitry, or any other elements capable of inputting information to and/or controlling the operation of the GPS receiver 62 and/or computing device 64.

The input and output (I/O) ports 72, 74 permit data and other information to be transferred to and from the computing device 64 and/or the GPS receiver 62. The input port 72 is preferably a serial port for receiving an irrigation control program from an external source as described in more detail below. The output port 74 is preferably a parallel port for controlling additional relays or other outputs should it be desired to expand the control functions of the GPS controller 60. The I/O ports may also include a TransFlash card slot for receiving removable TransFlash cards and a USB port for coupling with a USB cable connected to another computing device such as a personal computer.

The device 10 may also include a cellular or other radio transceiver for wirelessly receiving and transmitting data from and to remote devices. For example, the radio transceiver may permit the GPS controller 60 to communicate with the main controller 58 or a remote server, although such communication is not required.

The components shown in FIG. 4 and described above need not be physically connected to one another since wireless communication among the various depicted components is permissible and intended to fall within the scope of the present invention.

The housing of the GPS controller 60 is preferably constructed from a suitable vibration- and impact-resistant material such as, for example, plastic, nylon, aluminum, or any combination thereof. The housing preferably includes one or more appropriate gaskets or seals to make it substantially waterproof or resistant. The housing may include a location for a battery, or other power source for powering the electronic components of the GPS controller 60.

### OPERATION

Operation of the irrigation system 10 in a field 80 or other area to be irrigated is now explained with reference to FIGS. 1 and 2. The illustrated field 80 is rectangular, but the present invention works equally well with any sized and shaped field or other area to be irrigated. The illustrated field has four corners 82, 84, 86, 88 and a series of buildings, tanks or other obstructions 56 which at least partially block movement of portions of the irrigation system. The irrigation system 10 pivots about its central pivot 12 to irrigate the field 80 in a generally circular pattern, save for the area occupied by the obstructions 56. The end guns on the end tower may be activated at the appropriate time to irrigate the corners 82, 84, 86, 88 of the field 80 in a conventional manner. The pivoting joint 50 at the mobile tower 24 permits the spans 18, 20 to bend around the obstructions 56 as described above.

The irrigation system 10 and GPS controller 60 must first be set up prior to operation. To do this, the boundaries of the field 80 are determined through the use of GPS marking of the corners 82, 84, 86, 88 and other key boundary points of the field 80. Alternately, a map of the field 80 may be obtained from a database of existing imagery to determine the outline of the field. Through the use of the Lindsay Manufacturing Smart Design program or similar program, a custom irrigation design program is then created. The custom irrigation design program permits the irrigation system 10 to be designed to effectively fit the field to be irrigated. The program also determines the precise locations at which the end guns should be activated to maximize the end gun wetted area. Multiple end guns or other water-emitting devices can be selected and controlled with the program.

After the custom irrigation design program has been created to determine where the control areas of irrigation, chemigation, or fertigation applications should occur, the control program is uploaded to the computing device 64 of the GPS controller 60 through the serial port 72. While the irrigation system 10 is operational, the computing device 64 reads the current position of the end tower 28 from the GPS receiver 62 and determines when to control the relays 66, 68 in accordance with the custom irrigation design program. The additional inputs 70 may assist the computing device in determining the precise location of the end tower in the field when a differential correction signal is unavailable or when GPS signals are unavailable.

The following is one example of a control scheme for the irrigation system 10. When the system is first activated, all of the spans 14, 16, 18, 20 are aligned as shown in FIG. 1. The main controller 58 can thus accurately estimate the location of all the mobile towers 22, 24, 26, 28 with the signal from the encoder. At this point, the main controller 58 may control all of the water emitting devices, or the main controller 58 may control some and the GPS controller 60 may control some.

When the mobile tower 24 first reaches the barricade 54 shown in FIG. 2, the mobile towers 22, 24 stop moving, but the mobile towers 26, 28 may continue to move because of the articulating pivot joint 50 at mobile tower 24. Once the mobile towers 26, 28 begin to move independently of the central pivot 12, the main controller 58 turns off the water emitting devices on spans 14 and 16 and relinquishes control of the water emitting devices on spans 18 and 20 to the GPS controller 60. The computing device 64 of the GPS controller 60 reads location data from the GPS receiver 62, compares the current location of the end tower 28 to known references locations with the aid of the custom irrigation design program, and then activates and deactivates the water emitting devices on the spans 18 and 20 at the appropriate time. For example, the computing device 64 may activate all the downwardly directed sprayers on the spans 18 and 20 the entire time the mobile towers 26, 28 are moving and activate the end guns 48 only at the corners 82, 84, 86, 88 of the field to increase the amount of land that is irrigated. Once the portions of the field 80 adjacent the obstructions 56 have been irrigated, the mobile towers 26, 28 may reverse direction and re-align the spans 18, 20 with the spans 14, 16. Thereafter, all of the spans may move in alignment with the central pivot 12 until the irrigation system reaches another portion of the field 80 adjacent the obstructions 56.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An irrigation system comprising:
a central pivot connected to a source of fluid;
at least one intermediate tower;
an end tower;
a plurality of support sections spanning the central pivot, the intermediate tower, and the end tower;
a fluid distribution conduit supported by the support sections and coupled to the source of fluid;
a plurality of water-emitting devices supported along the length of the fluid distribution conduit for delivering fluids from the conduit to crops beneath the irrigation system;
a main controller positioned at or near the central pivot for controlling functions of the irrigation system; and
a controller positioned at or near the end tower and including
a location-determining component for determining a current location of the end tower, and
a computing device coupled with the location-determining component for controlling operation of selected ones of the water emitting devices based on the current location of the end tower and independent of control functions of the main controller.

2. The irrigation system as set forth in claim 1, wherein the location-determining component is a GPS receiver operable for receiving satellite signals from a plurality of GPS satellites and for determining a current location of the end tower as a function of the received satellite signals.

3. The irrigation system as set forth in claim 1, further including a pivoting joint at the intermediate tower which permits the end tower, the second support section and the second section of the conduit, to continue moving after the intermediate tower has stopped moving.

4. The irrigation system as set forth in claim 1, wherein the source of fluid is a water well.

5. The irrigation system as set forth in claim 1, wherein the selected ones of the water emitting devices include at least one end gun positioned on the end tower.

6. The irrigation system as set forth in claim 1, wherein the computing device is a processor.

7. The irrigation system as set forth in claim 1, wherein the controller positioned at or near the end tower includes at least one relay interposed between the computing device and the selected ones of the water emitting devices.

8. The irrigation system as set forth in claim 1, wherein the support sections are truss-type frameworks.

9. The irrigation system as set forth in claim 3, wherein the controller positioned at or near the end tower continues to operate the selected ones of the water emitting devices after the intermediate tower has stopped moving.

10. An irrigation system comprising:
a stationary central pivot connected to pressurized water source;
at least one mobile intermediate mobile tower;
a first support section spanning the central pivot and the intermediate tower;
a mobile end tower;
a second support section spanning the end tower and the intermediate tower;
a fluid distribution conduit coupled to the water source and including a first section supported by the first support section and a second section supported by the second support section;
a pivoting joint at the intermediate tower which permits the end tower, the second support section and the second section of the conduit, to continue moving after the intermediate tower, the first support section and the first section of conduit have stopped moving;
a plurality of water-emitting devices connected to the first section of the fluid distribution conduit and at least one water emitting device connected to the second section of the fluid distribution conduit;
a main controller positioned at or near the central pivot for controlling speed, direction, and fluid application functions of the irrigation system; and
a GPS controller positioned at or near the end tower and including
a GPS receiver for receiving satellite signals from a plurality of GPS satellites and for determining a current location of the end tower as a function of the received satellite signals,
a computing device coupled with the GPS receiver for determining when the current location of the end tower matches a location at which the water emitting device connected to the second section of the fluid distribution conduit should be activated, and
a relay controlled by the computing device for activating the water emitting device connected to the second section of the fluid distribution conduit when directed by the computing device and independent of the main controller.

11. The irrigation system as set forth in claim 10, wherein the GPS receiver receives a calibration signal from a calibration source.

12. The irrigation system as set forth in claim 10, wherein the pivoting joint permits the end tower, the second support section and the second section of the conduit, to articulate up to 165° relative to the central pivot after the intermediate tower has stopped moving.

13. The irrigation system as set forth in claim 10, wherein the source of fluid is a water well.

14. The irrigation system as set forth in claim 10, wherein the water emitting device connected to the second section of the fluid distribution conduit includes at least one end gun positioned on the end tower.

15. The irrigation system as set forth in claim 10, wherein the computing device is a processor.

16. The irrigation system as set forth in claim 10, wherein the GPS controller further includes an input port for receiving a custom irrigation control program for use in controlling the computing device.

17. The irrigation system as set forth in claim 10, wherein the support sections are truss-type frameworks.

18. The irrigation system as set forth in claim 16, wherein the GPS controller operates the water emitting devices in accordance with the custom irrigation control program.

19. A control system for an irrigation system including a plurality of mobile towers and a plurality of water emitting devices supported by the towers, the control system comprising:
a main controller for controlling certain speed, direction, and fluid applications of the irrigation system; and
a GPS controller including
a GPS receiver for receiving satellite signals from a plurality of GPS satellites and for determining a current location of one of the mobile towers as a function of the received satellite signals, and
a computing device coupled with the GPS receiver for determining when the current location of the one mobile tower matches a reference position and for activating selected ones of the water emitting devices at that time independently of the main controller.

20. The control system as set forth in claim 19, wherein the mobile towers include an end tower and wherein the computing device activates an end gun on the end tower when the current location matches the reference position.

21. A lateral move irrigation system comprising:
a plurality of moveable towers connected to a source of fluid, wherein one of the moveable towers is equipped with a pivoting joint so that a downstream tower may pivot about the pivoting joint independently of the other moveable towers;
a plurality of support sections spanning the moveable towers;
a fluid distribution conduit supported by the support sections and coupled to the source of fluid;
a plurality of water-emitting devices supported along the length of the fluid distribution conduit for delivering fluids from the conduit to crops beneath the irrigation system;
a main controller positioned on one of the moveable towers for controlling functions of the irrigation system; and
a controller positioned on the downstream tower and including
a location-determining component for determining a current location of the downstream tower, and
a computing device coupled with the location-determining component for controlling operation of selected ones of the water emitting devices based on the current location of the downstream tower and independent of control functions of the main controller.

22. The irrigation system as set forth in claim 21, wherein the moveable towers are operable to move laterally across an area to be irrigated.

23. The irrigation system as set forth in claim 21, wherein the location-determining component is a GPS receiver operable for receiving satellite signals from a plurality of GPS satellites and for determining a current location of the downstream tower as a function of the received satellite signals.

24. The irrigation system as set forth in claim 21, wherein the source of fluid is a water well.

25. The irrigation system as set forth in claim 21, wherein the selected ones of the water emitting devices include at least one end gun positioned on the downstream tower.
